(19) United States
(12) Patent Application Publication
(10) Pub. No.: US 2017/0357793 A1
(43) Pub. Date: Dec. 14, 2017

(54) PASSNUMBER AND IMAGE BASED METHOD AND COMPUTER PROGRAM PRODUCT TO AUTHENTICATE USER IDENTITY

(71) Applicant: Mohammed R. A. Nasrallah, Ajman (AE)

(72) Inventor: Mohammed R. A. Nasrallah, Ajman (AE)

(21) Appl. No.: 15/178,421

(22) Filed: Jun. 9, 2016

(51) Int. Cl. G06F 21/36; G06F 3/0482; G06F 3/0481

(52) U.S. Cl. CPC G06F 21/36; G06F 3/04817; G06F 3/0482

(57) ABSTRACT

An authentication process is disclosed which uses categories of icons to create an easy to remember passnumber for use with an electronic platform. The process may assign each icon a discrete value during registration. A hash value is created based on combining the discrete values for each icon in the passnumber. During a login process, the user is presented with the icons, sometimes in a randomly shuffled. The user may input the icons that make up his or her passnumber. The process may access stored values for user selected icons in the login passnumber entry field and calculate a login hash value. The process may then determine whether the login hash value matches the registration hash value to permit or deny login access to the electronic platform.

### CROSS-REFERENCE TO RELATED APPLICATIONS

None.

### BACKGROUND

The embodiments herein relate generally to security systems, and more particularly, to a passnumber and image based method and computer program product to authenticate user identity.

With the proliferation of individual transactions occurring on electronic accounts, users must maintain a number of passwords. Conventional authentication systems may be complex requiring the user to remember alphanumeric combinations. In an effort to create more robust and harder to hack passwords, some current authentication processes require the alphanumeric sequence to include capitalization in tandem with keyboard symbols. The more complex password requirements become, the more difficult it becomes for individuals to recall and track their various passwords.

Yet increasing password complexity still leaves passwords susceptible to theft by, for example thieves physically looking over one's shoulder during password entry or by using malware on a computer to record keystrokes. Once viewed or recorded, it becomes a simple matter to hack into one's account(s).

As can be seen, there is a need for an improved authentication process that uses an easily remembered passkey that increases the difficulty of theft and hacking.

### SUMMARY

In an exemplary embodiment of the present invention, a computer program product for authenticating a user's identity in an electronic platform, comprises a non-transitory computer readable storage medium having computer readable program code embodied therewith. The computer readable program code is configured to: generate during a registration process, by a processor, a field of rows of categories and icons for each category, on an electronic display; assign by the processor, a static discrete value to each icon and a position in the field; receive by the processor, user selected icons from a plurality of the categories, the user selected icons representing a hash value associated with a user; determine, by the processor, a registration hash value based on aggregating the discrete values of the user selected icons; store the registration hash value in association with the user; display, by the processor, on the electronic display during a login process, a presentation of the rows of categories and icons for each category; receive by the processor, a passnumber entry for login based on user selected input of icons selected from the presentation displayed during the login process; determine by the processor, a value for each of received user selected input of icons; determine, by the processor, a login hash value based on aggregating the values of each of the received user selected input of icons; and determine by the processor, a successful or unsuccessful login to the electronic platform by the user based on whether the login hash value matches the registration hash value.

In another exemplary embodiment, a server system comprises a processor configured to: generate during a registration process, by a processor, a field of rows of categories and icons for each category, on an electronic display; assign by the processor, a static discrete value to each icon and a position in the field; receive by the processor, user selected icons from a plurality of the categories, the user selected icons representing a hash value associated with a user; determine, by the processor, a registration hash value based on aggregating the discrete values of the user selected icons; store the registration hash value in association with the user; display, by the processor, on the electronic display during a login process, a presentation of the rows of categories and icons for each category; receive by the processor, a passnumber entry for login based on user selected input of icons selected from the presentation displayed during the login process; determine by the processor, a value for each of received user selected input of icons; determine, by the processor, a login hash value based on aggregating the values of each of the received user selected input of icons; and determine by the processor, a successful or unsuccessful login to the electronic platform by the user based on whether the login hash value matches the registration hash value.

In another exemplary embodiment, a method of authenticating a user's identity in an electronic platform comprises generating during a registration process, by a processor, a field of rows of categories and icons for each category, on an electronic display; assigning by the processor, a static discrete value to each icon and a position in the field; receiving by the processor, user selected icons from a plurality of the categories, the user selected icons representing a hash value associated with a user; determining, by the processor, a registration hash value based on aggregating the discrete values of the user selected icons; storing the registration hash value in association with the user; displaying, by the processor, on the electronic display during a login process, a presentation of the rows of categories and icons for each category; receiving by the processor, a passnumber entry for login based on user selected input of icons selected from the presentation displayed during the login process; determining by the processor, a value for each of received user selected input of icons; determining, by the processor, a login hash value based on aggregating the values of each of the received user selected input of icons; and determining by the processor, a successful or unsuccessful login to the electronic platform by the user based on whether the login hash value matches the registration hash value.

### BRIEF DESCRIPTION OF THE FIGURES

The detailed description of some embodiments of the invention is made below with reference to the accompanying figures, wherein like numerals represent corresponding parts of the figures.

FIG. 1 is a flowchart of a method authenticating a user's identity in an electronic platform according to an embodiment of the subject technology.

FIG. 2 is a screenshot of a registration process displayed in a method authenticating a user's identity in an electronic platform according to an embodiment of the subject technology.

FIG. 3 is a screenshot of FIG. 2 showing a passnumber generated by user selections according to an embodiment of the subject technology.

FIG. 3A is a table of discrete values for each object and its position in the display of objects used for generating a passnumber of FIG. 2 according to an embodiment of the subject technology.

FIG. 4 is a screenshot of a login screen displayed in a method authenticating a user's identity in an electronic platform according to an embodiment of the subject technology.

FIG. 5A is screenshot of a user input of a passnumber based on presentation of icons shown in FIG. 4.

FIG. 5B is a table of discrete values for each object in the display of objects shown in FIGS. 4 and 5A according to an embodiment of the subject technology.

FIG. 6A is a screenshot of a registration process displayed in a method authenticating a user's identity in an electronic platform according to an alternate embodiment of the subject technology.

FIG. 6B is a screenshot of a registration process displayed in a method authenticating a user's identity in an electronic platform according to an alternate embodiment of the subject technology.

FIG. 7 is a block diagram of a computer system/server according to an embodiment of the subject technology.

### DETAILED DESCRIPTION OF CERTAIN EMBODIMENTS

In general, embodiments of the subject technology provide a passnumber system and process for user authentication on an electronic platform that provides the user with improved security and easier to recall inputs for entry. Advanced security features permit the user to enter elements of their passnumber neither having to worry about the order of entry or if they are being spied upon over their shoulder.

Exemplary embodiments present the user with a field of symbols organized into categories. Each category includes multiple icons (symbols) which may be easily identifiable objects from daily life. During registration and as described in more detail below, once the user selects the icons that will form his or her passnumber, the user only needs to remember which icons are in the passnumber for entry during login; the sequence of icon entry is not necessary. As will be seen, during login, the user will be presented with the categories and icons again but not necessarily in the same order presented during registration.

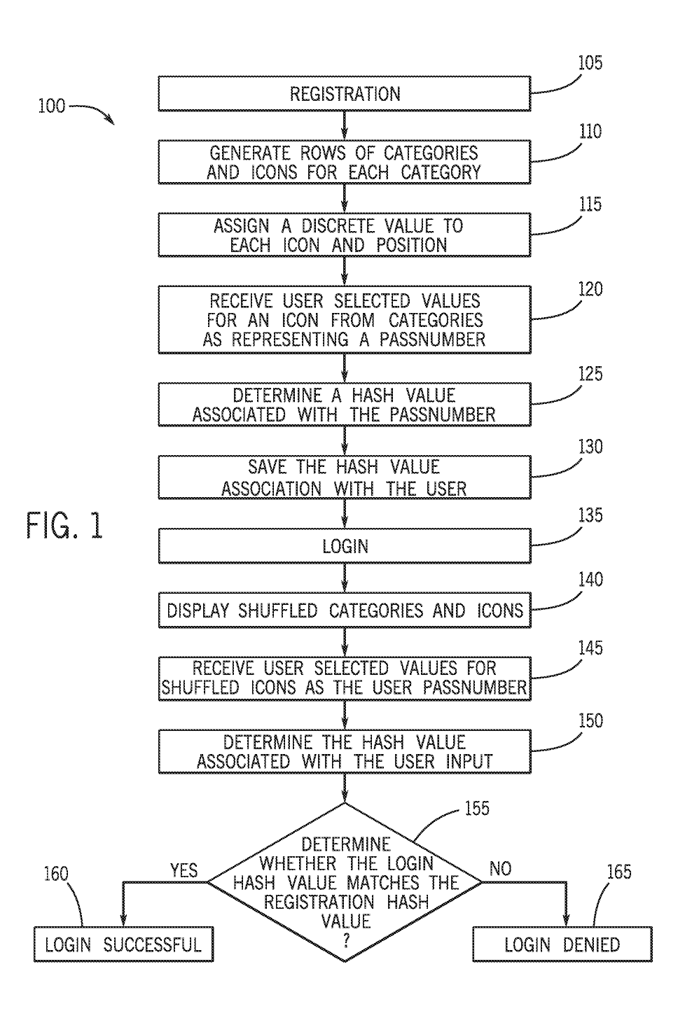

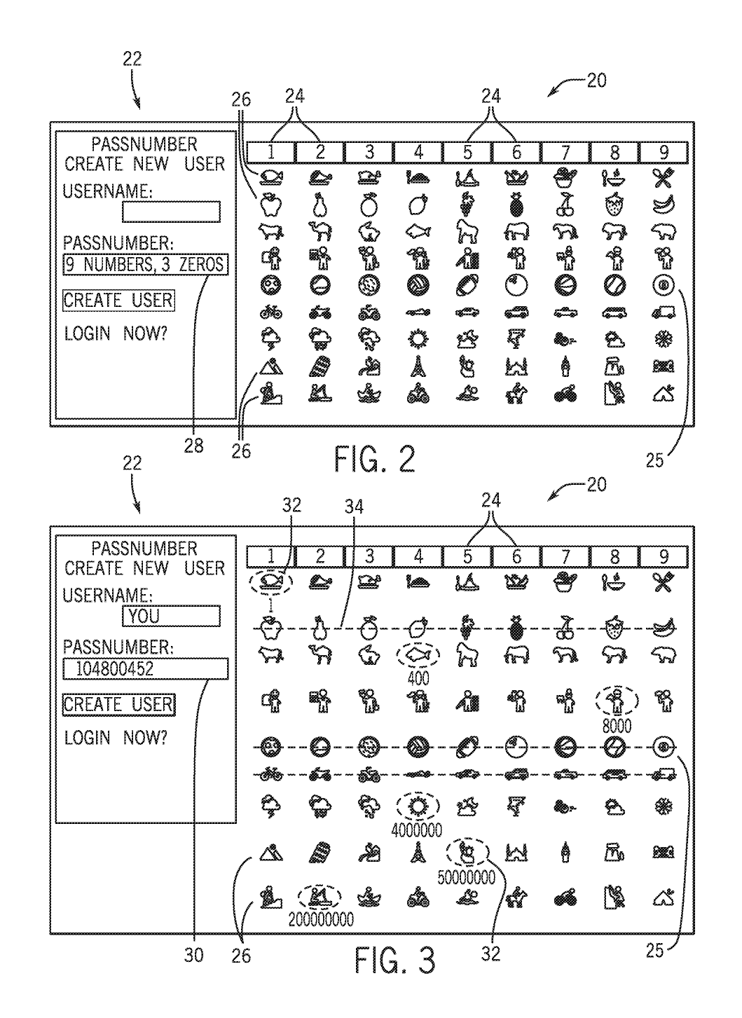

Referring now to FIG. 1 a method 100 of authenticating a user's identity in an electronic platform is shown according to an exemplary embodiment. FIGS. 2, 3, 3A, 4, 5A, 5B, 6A, and 6B show a series of screenshots illustrating user interaction with an electronic platform implementing aspects of the subject method of authentication. Thus it may be helpful to refer to FIGS. 2, 3, 3A, 4, 5A, 5B, 6A, and 6B concurrently with FIG. 1. To distinguish between process steps and physical elements, the process steps will be shown in parenthesis. As will be understood and described further below with respect to FIG. 7, steps described in the method 100 are generally performed by a processor unless indicated otherwise.

The method 100 may begin with initiating (105) the registration process on an electronic platform. The screenshot shown in FIG. 2 represents a registration screen displayed to the user. The electronic platform may display a field 20 in the registration screen. The field 20 may comprise a plurality of category rows 26 generated (110) to include within each category a plurality of icons 25. The categories may be themed so that elements of each category are easily recognizable by the user. For sake of illustration only, four rows of categories (meal types, fruits, famous tourist monuments, and outdoor sporting activities) and a single icon 25 (a billiard ball) are called out. As will be appreciated, the icons 25 can be easily memorized by the user because the user may select icons that are for example, their favorite member of each category or may represent a mnemonic of some subject they can easily remember. In some embodiments, the position of categories 26 and icons 25 within each category in the registration screen is the same for all new registering users. In other embodiments, a file may be stored capturing the position of categories 26/icons 25 for each user during registration so that the initial position of icons 25 and their value (as explained below) is user dependent.

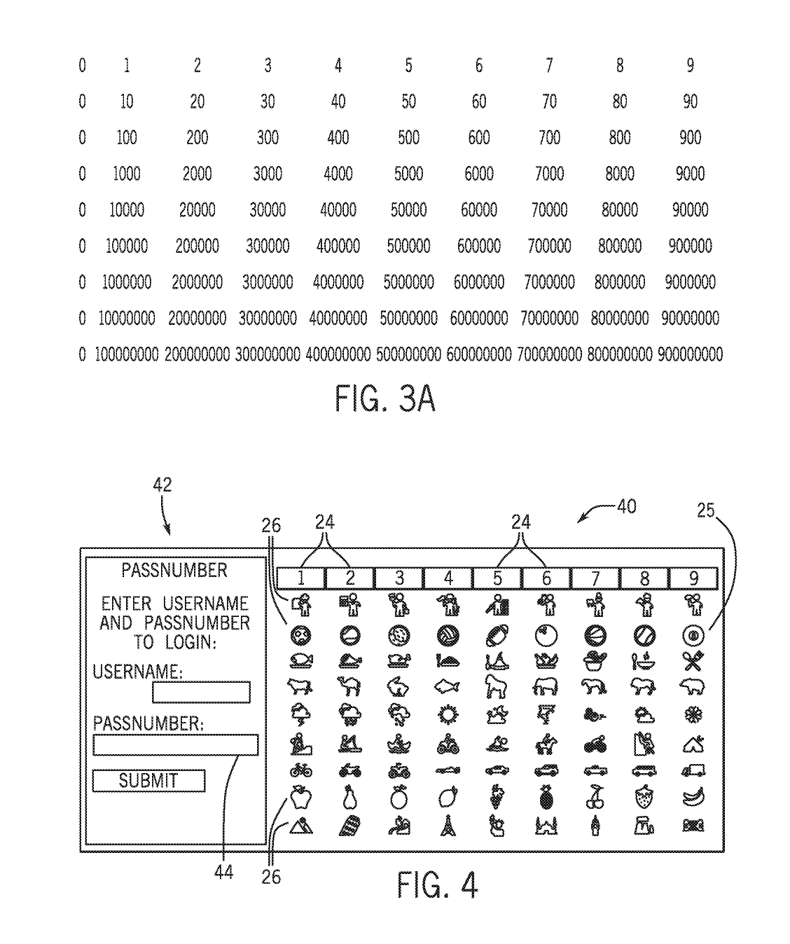

Each icon may be assigned a registration position in the field 20 based on their column and row during the registration screen. Each position in the field 20 may be assigned (115) a discrete value. For example, as shown in FIGS. 3 and 3A, the cells represent discrete values for each position in a 9 category×9 column field of icons. The discrete values for each position (along with the icon 25 in that position) is stored in a file for future access.

The user may select an icon 25 from two or more of a plurality of categories 26 which is input and received (120) by the system. In some embodiments, the user may select how many categories 26 will be used to establish the passnumber. For example, during registration, an input module 22 may include entry fields for receiving a user name and a passnumber field 28 indicating how many categories 26 will have a non-null value (a selected icon 25) and how many categories 26 will be a null value. The first column of zeros in FIG. 3A represents null values for categories 26 in which the user has determined will not have an icon 25 selected for that category. As shown by example in FIG. 3, the user has selected 9 categories 26; 6 categories 26 with an icon 25 selected in each and 3 of the categories 26 that will not have a selection. FIG. 2 at 28 shows this as text explaining the passnumber will include 9 numbers total with 3 numbers being zero values. It will be appreciated that using null values may increase security for the user since only the user knows which categories are false positives as will be seen during the login process.

As shown in FIG. 3, the three categories 26 that are not part of the passnumber are crossed out by a line 34 which is shown for illustrative purposes only. A circle is shown around user selected icons 25 along with a discrete value associated for the object based on its position (for sake of illustration only), in the remaining respective categories 26. A few of the selected icons are called out as selections 32. These are shown as the fishmeal in the first row, the shark in the 3^{rd} row, the chef in the 4^{th} row, a symbol for sunny weather in the 7^{th} row, the statue of Liberty in the 8^{th} row, and the fisherman in the 9^{th} row. The 2^{nd}, 5^{th}, and 6^{th} rows are null values in this example. A passnumber 30 of these user selections is shown by the user inputting (120) the position value of the selections 32 in the row for each category 26. The fish is in position 1, so going by order of row number, the first digit of the passnumber 30 is “1”. The 2^{nd} row does not include a selection so the next number in the passnumber 30 is “0”. The next category 26 shows the selection of the shark in the 4^{th} position so the next digit in the passnumber 30 is “4”. The chef is in the 8^{th} position in row 4 so the next digit is “8”. Rows 5 and 6 do not have selections so the next two digits in the passnumber 30 are “0” and “0”. The next 3 selections 32 (“sunny”, “statue of Liberty”, and “fisherman” are in the 4^{th}, 5^{th}, and 2^{nd} positions so the next 3 digits are “4”, “5”, and “2”. The resultant passnumber will be in this example “104800452”

In another embodiment, selection of icons 25 may be input into the field for passnumber 30 by using a GUI such as a mouse or touch screen system to select the icons 25. In embodiments using a GUI selection feature, the order of entry for icons 25 into the field for passnumber 30 may be arbitrary as selected by the user. Some embodiments may hide user input from view by using for example, a placeholder (such as an asterisk).

After receiving the user selected input, the method 100 determines (125) a hash value associated with the passnumber 30. The hash value may be calculated by aggregating the discrete value for each icon position (for example, the values shown in FIG. 3A). Thus, for example, referring to the passnumber “104800452” generated by user selection in FIG. 3, the positions of each respective digit represents values associated with the (1^{st} row, 1^{st} position), (2^{nd} row, 0 value), (3^{rd} row, 4^{th} position), (4^{th} row, 8^{th} position), (5^{th} row, 0 value), (6^{th} row, 0 value), (7^{th} row, 4^{th} position), (8^{th} row, 5^{th} position), and (9^{th} row, 2nd position). With reference to FIG. 3A, the aggregation of these values is “1”+“0”+“400”+“8000”+“0”+“0”+“4000000”+“50000000”+“200000000”. The hash value for the shown passnumber 30 is thus “254008401”. The hash value may be stored (130) in association with the user.

The method 100 may continue with initiating (135) a login process. As will be understood by those of ordinary skill in the art, the registration process and the login process may be temporally displaced. The registration process may occur once while subsequently the login process may occur multiple times for the passnumber 30 created during registration.

Referring to FIG. 4, a screenshot of a login screen is displayed to the user. The login screen may include a user input entry module 42 for receiving a user input passnumber. A field 40 of the categories 26 and icons 25 from the registration process is displayed to the user. In an exemplary embodiment, the field 40 may randomly shuffle for display (140), the positions of the categories 26 in different rows than the rows they occupied respectively during the registration process. In addition, the positions of the icons 25 may be randomly shuffled to occupy different positions (as displayed (140)) within their respective categories (for example, in a different column 24) than what was displayed during the registration process.

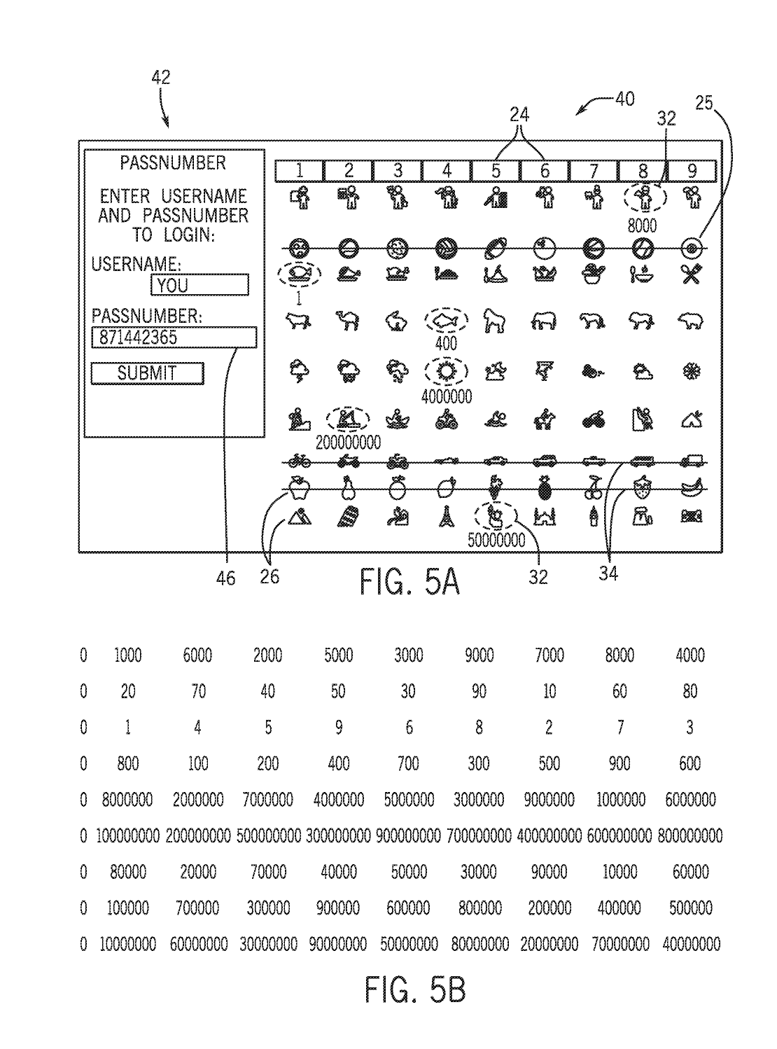

Referring now to FIGS. 5A and 5B, the user may identify the icons 25 that comprise their passnumber. As will be appreciated, the icons 25 are easy to recall regardless of their newly presented position in the field 40. The user may input (145) user selections 32 into a passnumber field 46. The categories that did not include a selection during the registration process will be a null value and are not considered during determination of a correctly input passnumber. In some embodiments, the authentication system may allow the user to enter a non-null value for categories 26 that were null values for the passnumber generated during the registration process. Since these categories 26 are not part of the registration hash value calculation, the authentication process may ignore a non-null value entered for rows of categories that are a null value. It will be appreciated however that, in operation, if a user is being spied upon (either physically or electronically by for example, keystroke recording), the arbitrary selections entered in for null-value categories make it nearly impossible for a thief to know which values are false when stealing a passnumber. The remaining categories 26 and their respective icons 25 that make up the passnumber are entered according to their position in order by row number and column number. As shown, the user selections 32 from FIG. 3 are displayed according to a passnumber to be entered as “801442005”. For embodiments allowing false entry of null values into the passnumber entry, an example of a passnumber including false values in null value category positions may look like “871442365” (showing the “0”s replaced by arbitrary values). Some embodiments may allow the user to select passnumber input by using a GUI for selecting icons 25 (including false selections for null-value categories 26). Some embodiments may thus allow for selection of icons 25 in an arbitrary order; including for example, starting their selection (entry) from any row or column while completing a continuous sequence of entry. However, as will be appreciated, these features add more layers of security protection for the user as a thief does not know the sequence is arbitrary, or where it from the field 40, passnumber elements were started from or ended, yet the calculation for authentication described below remains unaffected.

In an exemplary embodiment, the method 100 may include a user selectable feature for direction of passnumber entry. The user can select from among registration options his or her method to enter the direction of the passnumber's input, for example, from right to left or vice versa. In addition, the method 100 may include a feature from among registration options his or her method to enter the direction of the passnumber's input, for example, in order from top row to bottom row or vice versa. As will be appreciated, since the passnumber is based on object recognition and positioning of the objects, adding directionality dimensions to the passnumber input will not affect the accuracy of the passnumber entry but will make it more difficult for thieves to follow sequences of passnumber entry adding another layer of security.

The method 100 may determine (150) the hash value associated with the user input of step (145). In determining the hash value for login, the system may look up the stored discrete value associated with each icon 25 selected by the user during the registration process. As will be understood, the discrete value for each selection 32 has not changed because of their new position in field 40 but rather the discrete values are static for each icon 25 and are maintained from the registration process (105) and through each login process (135), The discrete values for user selections 32 in the login process (135) may be aggregated for calculating the login hash value. Authentication may proceed by determining (155) whether the login hash value matches the registration hash value. For example, if the aggregate of discrete values in the login process equal “254008401”, then login is determined (160) as successful and user authentication is complete allowing the user access to the electronic platform; otherwise if the hash values do not match then login is determined (165) as unsuccessful and entry may be denied.

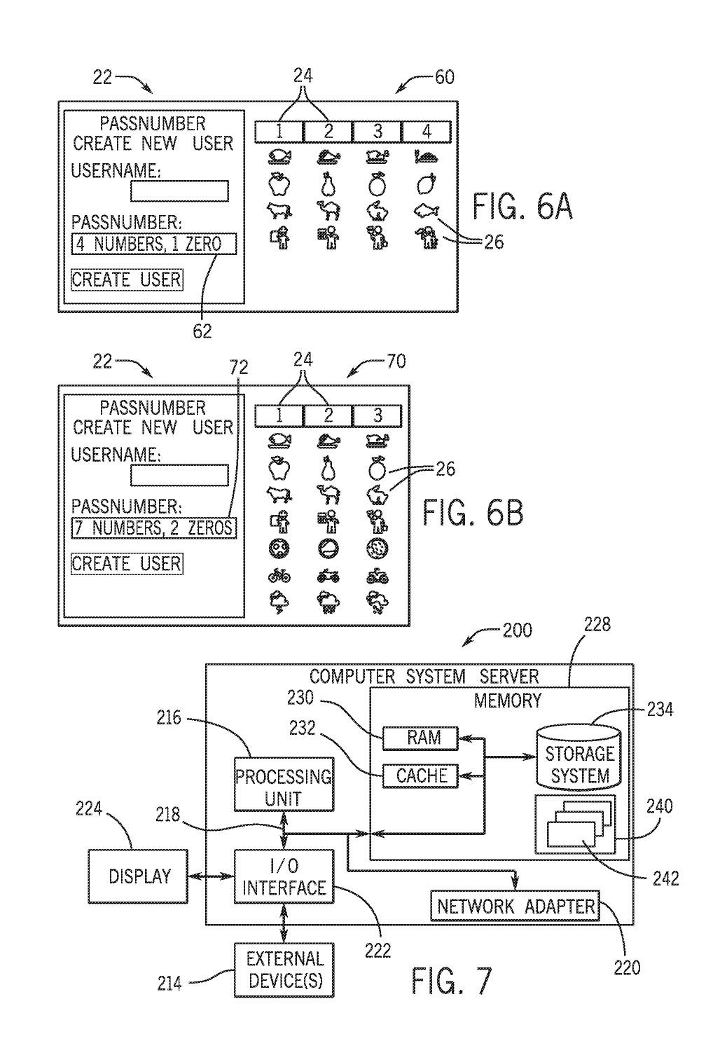

Referring now to FIGS. 6A and 6B, an alternate embodiment of an electronic display for user authentication is shown. During registration, it will be understood that the user may be presented with a field with any number of columns and rows without departing from the scope of the authentication process disclosed. For example, in FIG. 6A a field 60 is shown with 4 rows and 4 columns. The passnumber entry field 62 will have 4 values with one value being a null value. In FIG. 6B, a field 70 displays 7 categories 26 with 3 columns 24 of icons per category 26. The passnumber entry field 72 will receive a user entry of 7 values with 2 values being a null value.

Referring now to FIG. 7, a schematic of an example of a computer system/server 200 is shown. The computer system/server 200 is shown in the form of a general-purpose computing device. The computer system/server 200 may serve the role as the machine implementing for example the functions of generating registration and login screens, generating fields of categories and icons, assigning discrete values, calculating hash values, storing passnumbers in association with users, and determining successful/unsuccessful logins. The components of the computer system/server 200 may include, but are not limited to, one or more processors or processing units 216, a system memory 228, and a bus 218 that couples various system components including the system memory 228 to the processor 216.

The computer system/server 200 may perform functions as different machine types depending on the role in the system the function is related to. For example, depending on the function being implemented at any given time when interfacing with the system, the computer system/server 200 may be for example, personal computer systems, tablet devices, mobile telephone devices, handheld or laptop devices, multiprocessor systems, microprocessor-based systems, set top boxes, programmable consumer electronics, electronic locks with passnumber interfaces, network PCs, and distributed cloud computing environments that include any of the above systems or devices, and the like providing electronic platforms including authentication processes disclosed herein and electronic screens for user interface. In some embodiments, the computer system/server 200 is a server(s) computer systems hosting the authentication process for use in third party sites. The computer system/server 200 may be described in the general context of computer system executable instructions, such as program modules, being executed by a computer system (described for example, below). In some embodiments, the computer system/server 200 may be a cloud computing node connected to a cloud computing network (not shown). The computer system/server 200 may be practiced in distributed cloud computing environments where tasks are performed by remote processing devices that are linked through a communications network. In a distributed cloud computing environment, program modules may be located in both local and remote computer system storage media including memory storage devices.

The computer system/server 200 may typically include a variety of computer system readable media. Such media could be chosen from any available media that is accessible by the computer system/server 200, including non-transitory, volatile and non-volatile media, removable and non-removable media. The system memory 228 could include random access memory (RAM) 230 and/or a cache memory 232. A storage system 234 can be provided for reading from and writing to a non-removable, non-volatile magnetic media device. The system memory 228 may include at least one program product 240 having a set (e.g., at least one) of program modules 242 that are configured to carry out the functions of embodiments of the invention. The program product/utility 240, having a set (at least one) of program modules 242, may be stored in the system memory 228. The program modules 242 generally carry out the functions and/or methodologies of embodiments of the invention as described herein.

The computer system/server 200 may also communicate with one or more external devices 214 such as a keyboard, a pointing device, a display 224, etc.; and/or any devices (e.g., network card, modem, etc.) that enable the computer system/server 200 to communicate with one or more other computing devices. Such communication can occur via Input/Output (I/O) interfaces 222.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 216 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for authenticating a user's identity in an electronic platform, the computer program product comprising a non-transitory computer readable storage medium having computer readable program code embodied therewith, the computer readable program code being configured to:
generate during a registration process, by a processor, a field of rows of categories and icons for each category, on an electronic display;
assign by the processor, a static discrete value to each icon and a position in the field;
receive by the processor, user selected icons from a plurality of the categories, the user selected icons representing a hash value associated with a user;
determine, by the processor, a registration hash value based on aggregating the discrete values of the user selected icons;
store the registration hash value in association with the user;
display, by the processor, on the electronic display during a login process, a presentation of the rows of categories and icons for each category;
receive by the processor, a passnumber entry for login based on user selected input of icons selected from the presentation displayed during the login process;
determine by the processor, a value for each of received user selected input of icons;
determine, by the processor, a login hash value based on aggregating the values of each of the received user selected input of icons; and
determine by the processor, a successful or unsuccessful login to the electronic platform by the user based on whether the login hash value matches the registration hash value.

2. The computer program product of claim 1, wherein positions of the rows of categories during the login process is shuffled randomly and is different than locations for the rows of categories displayed during the registration process.

3. The computer program product of claim 2, wherein positions of the icons in the rows of categories during the login process is shuffled randomly and is different than locations for the icons in the rows of categories displayed during the registration process.

4. The computer program product of claim 1, further comprising computer readable program code being configured to receive from the passnumber entry the user selected input of icons, during either the login process or registration, in a user selected order of entry starting from left to right or right to left from any column and from up to down or down to up from any row, in the presentation of the rows of categories and icons for each category.

5. The computer program product of claim 1, wherein one or more of the categories among the rows of categories is a null value.

6. A server system comprises a processor configured to:
generate during a registration process, by a processor, a field of rows of categories and icons for each category, on an electronic display;
assign by the processor, a static discrete value to each icon and a position in the field;
receive by the processor, user selected icons from a plurality of the categories, the user selected icons representing a hash value associated with a user;
determine, by the processor, a registration hash value based on aggregating the discrete values of the user selected icons;
store the registration hash value in association with the user;
display, by the processor, on the electronic display during a login process, a presentation of the rows of categories and icons for each category;
receive by the processor, a passnumber entry for login based on user selected input of icons selected from the presentation displayed during the login process;
determine by the processor, a value for each of received user selected input of icons;
determine, by the processor, a login hash value based on aggregating the values of each of the received user selected input of icons; and
determine by the processor, a successful or unsuccessful login to the electronic platform by the user based on whether the login hash value matches the registration hash value.

7. The server system of claim 6, wherein the processor is configured to randomly shuffle positions of the rows of categories for display during the login process in locations that are different than for the rows of categories displayed during the registration process.

8. The server system of claim 7, wherein the processor is configured to randomly shuffle positions of icons in the rows of categories for display during the login process in locations that different than for icons in the rows of categories displayed during the registration process.

9. The server system of claim 6, wherein the processor is configured to receive from the passnumber entry the user selected input of icons, during either the login process or registration, in a user selected order of entry starting from left to right or right to left from any column and from up to down or down to up from any row, in the presentation of the rows of categories and icons for each category.

10. The server system of claim 6, wherein one or more of the categories among the rows of categories is a null value.

11. A method of authenticating a user's identity in an electronic platform, comprising:
generating during a registration process, by a processor, a field of rows of categories and icons for each category, on an electronic display;
assigning by the processor, a static discrete value to each icon and a position in the field;
receiving by the processor, user selected icons from a plurality of the categories, the user selected icons representing a hash value associated with a user;
determining, by the processor, a registration hash value based on aggregating the discrete values of the user selected icons;
storing the registration hash value in association with the user;
displaying, by the processor, on the electronic display during a login process, a presentation of the rows of categories and icons for each category;
receiving by the processor, a passnumber entry for login based on user selected input of icons selected from the presentation displayed during the login process;
determining by the processor, a value for each of received user selected input of icons;
determining, by the processor, a login hash value based on aggregating the values of each of the received user selected input of icons; and
determining by the processor, a successful or unsuccessful login to the electronic platform by the user based on whether the login hash value matches the registration hash value.

12. The method claim 11, wherein the processor is configured to randomly shuffle positions of the rows of categories for display during the login process in locations that are different than for the rows of categories displayed during the registration process.

13. The method of claim 12, wherein the processor is configured to randomly shuffle positions of icons in the rows of categories for display during the login process in locations that different than for icons in the rows of categories displayed during the registration process.

14. The method of claim 11, wherein the processor is configured to receive from the passnumber entry the user selected input of icons, during either the login process or registration, in a user selected order of entry starting from left to right or right to left from any column and from up to down or down to up from any row, in the presentation of the rows of categories and icons for each category.

15. The method of claim 11, wherein one or more of the categories among the rows of categories is a null value.

16. The method of claim 11, wherein, in the step of receiving by the processor, a passnumber entry for login based on user selected input of icons selected from the presentation displayed during the login process, the user selected icons are received in an arbitrary user selected order of entry starting from any row or column in the presentation of the rows of categories and icons for each category.
